(19) United States
(12) Patent Application Publication
(10) Pub. No.: US 2003/0182575 A1
(43) Pub. Date: Sep. 25, 2003

(54) Performing encryption-oriented action on document at host device prior to transmission to printer-related device over network

(76) Inventor: Craig M. Korfanta, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/103,018

(22) Filed: Mar. 21, 2002

(51) Int. Cl. G09C 3/08

(52) U.S. Cl. 713/201

(57) ABSTRACT

Performing an encryption-oriented action on a document at a host device prior to transmitting the document to a printer-related device over a network is disclosed. The document is first converted and has an encrypted-oriented action performed thereon at a host device. The host device further wraps the document in a wrapper having a decryption-oriented action command, and sends the document to the printer-related device over the network. The printer-related device unwraps the document from the wrapper. Upon encountering the decryption-oriented action command, the printer-related device performs a decryption-oriented action on the document. The printer-related device finally prints the document.

### FIELD OF THE INVENTION

This invention relates generally to printing documents, and more particularly to the transmission of such documents from a host device to a printer-related device over a network.

### BACKGROUND OF THE INVENTION

One of the more popular peripherals for computers is the printer. Using a printer, a user can print a document onto media, such as most commonly paper. The ability to print so-called hardcopies of documents allows users to exchange copies of the documents, even if the recipients do not have access to a computer to view the electronic versions of the documents.

Originally, printers were connected directly to computers. Each computer that needed printing capability thus had to have a printer attached to it. However, this became inefficient, since most of the time a printer attached to a single computer remains unused. Therefore, more recently printers have been connected to networks, typically local-area networks (LAN's). A number of computers on the network could thus share the same printer or set of printers.

The use of network printers has recently been extended beyond LAN's, however. Recent innovations allow printers to be used across wide-area networks (WAN's), intranets, extranets, and even the Internet. A user on the West Coast, for instance, may now be able to print a document at a printer on the East Coast, where both the user's computer and the printer are communicatively coupled to the same network.

The introduction of such long-distance network printing has introduced some problems not previously considered with network printing on a LAN. A LAN, for instance, is usually a secure network, in which all the users using the network and the computers on the network are considered trusted. By comparison, the Internet is an insecure network. Competitors, hackers, and other parties may intercept data communicated over the Internet.

As a result, network printing over the Internet can be fraught with peril. The West Coast user printing a document at an East Coast printer may have his or her document intercepted at some point in-between, to the detriment of the user and/or his or her employer. Printing protocols and methodologies originally devised for LAN environments thus do not scale well to larger networks, such as the Internet, inasmuch as they do not account for possible document interception during document transmission from a computer to a printer over a network.

For these and other reasons, therefore, there is a need for the present invention.

### SUMMARY OF THE INVENTION

The invention relates to performing an encryption-oriented action on a document at a host device prior to transmitting the document to a printer-related device over a network. In a method of the invention, the document is first converted and has an encrypted-oriented action performed thereon, at a host device. The host device further wraps the document in a wrapper having a decryption-oriented action command, and sends the document to the printer-related device over the network. The printer-related device unwraps the document from the wrapper. Upon encountering the decryption-oriented action command, the printer-related device performs a decryption-oriented action on the document. The printer-related device finally prints the document.

A system of the invention includes a network, a host device, and a printer-related device. The host device is capable of converting a document according to a format, of performing an encryption-oriented action on the document, and of wrapping the document in a wrapper having a decryption-oriented action command. The printer-related device is capable of receiving the document from the host device over the network. The printer-related device is further capable of unwrapping the document, of performing a decryption-oriented action on the document upon encountering the decryption-oriented action command, and of printing the document.

A computer-readable medium of the invention has a program stored thereon for execution by a printer-related device. The program includes a module to unwrap a document from a wrapper in which the document has been wrapped by a host device. The program also includes a module to perform a decryption-oriented action on the document, upon the former module encountering a decryption-oriented action command while unwrapping the document.

At least some embodiments of the invention provide for advantages over the prior art. The host device performs an encryption-oriented action on the document prior to sending it over the network to the printer-related device. This encryption-oriented action may include encryption, compression, and so on. As a result, if the document were to be intercepted over the network prior to its receipt by the printer-related device, the intercepting party could not glean the contents of the document. Thus, at least some embodiments of the invention provide for secure document delivery over a network that may be unsecure.

Still other advantages, aspects, and embodiments of the invention will become apparent by reading the detailed description that follows, and by referring to the accompanying drawings.

### BRIEF DESCRIPTION OF THE DRAWINGS

FIG. 1 is a flowchart of a method according to an embodiment of the invention in which encryption of a document is performed prior to sending the document over a network to a printer-related device.

FIG. 2 is a flowchart of a method according to an embodiment of the invention in which rasterization and compression of a document is performed prior to sending the document over a network to a printer-related device.

FIGS. 3A and 3B are diagrams of systems according to differing embodiments of the invention.

FIG. 4 is a diagram showing how a printer-related device is receptive of addins for performing decryption-oriented actions or for providing decryption-oriented parameters, according to an embodiment of the invention.

FIG. 5 is a diagram of a computer program according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

Encryption Embodiment

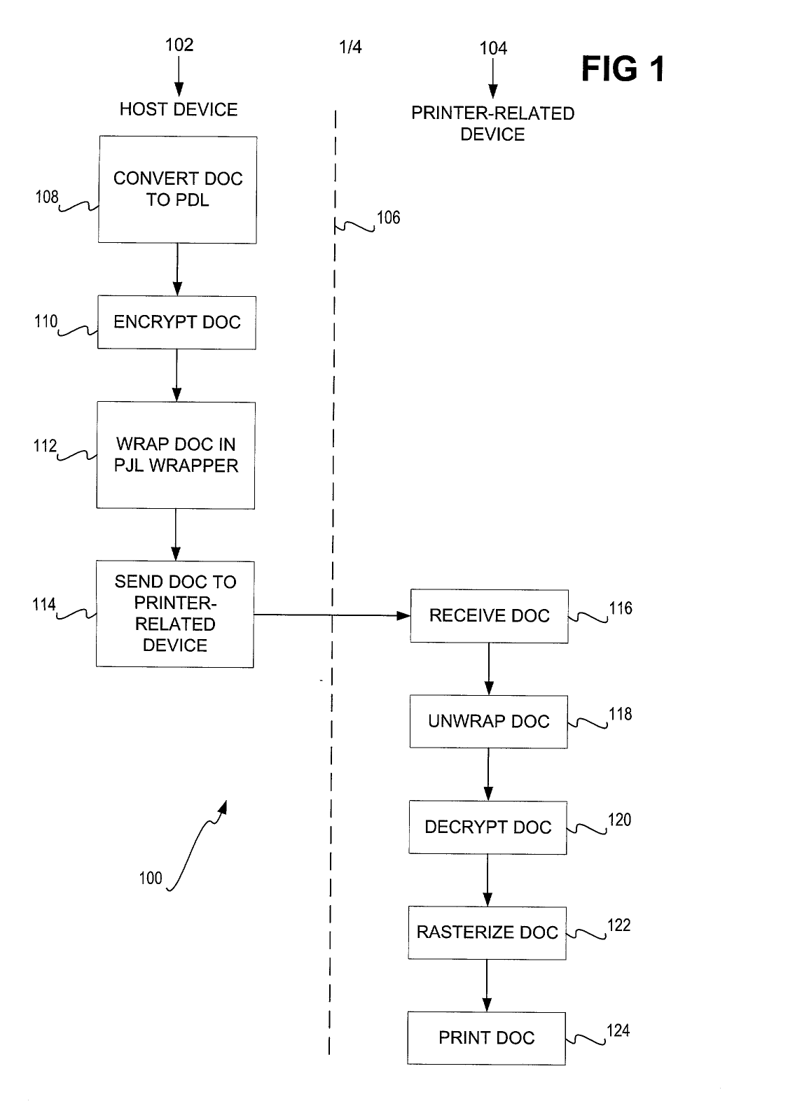

FIG. 1 shows a method 100 according to an embodiment of the invention in which a document is encrypted before being transmitted over a network. Parts of the method 100 are performed at a host device, as indicated by the column 102, whereas other parts of the method 100 are performed at a printer-related device, as indicated by the column 104. The columns 102 and 104 are separated by the dotted line 106. The host device may be a desktop or a laptop computer, a personal-digital assistance (PDA) device, or another type of computerized device. The printer-related device may include a printer, or may be a network printer server, or another type of printer-related device.

The host device first converts a document to be printed to a page-description language (PDL) (108). The PDL may be PostScript, the Printer Control Language (PCL), or another type of PDL. Generally, a PDL is a device-independent, high-level language for commanding a printer to print text and graphics on a page. The document is next encrypted (110). More generally, an encryption-oriented action is performed on the document.

Encryption is generally a process to encode a document for security purposes. The host device may use a particularly specified encryption algorithm, such as the Data Encryption Standard (DES), Rivest-Shamir-Adleman (RSA), Pretty Good Privacy (PGP), or another type of encryption algorithm. The document may be encoded using the same key as necessary to decrypt the document. Alternatively, the document may be encoded with the public key of the printer-related device, where the private key of the printer-related device is used to decrypt the document, in so-called public key-private key cryptography.

The host device then wraps the document in a printer-job language (PJL) wrapper (112). A PJL generally is a printer command language that adds control for individual print jobs and also includes the ability to set printer default settings. More specifically, the host device wraps the document in a PJL wrapper and includes a decryption-oriented action command in the wrapper. The host device finally sends the document to the printer-related device over a network (114). Because an encryption-oriented action has been performed on the document, the document is secure while it is being transmitted over the network. That is, should the document be intercepted, its contents cannot be gleaned.

The printer-related device receives the document (116), and unwraps the document from its PJL wrapper (118). In unwrapping the document from its PJL wrapper, the printer-related device encounters the decryption-oriented action command. In encountering this command, the printer-related device decrypts the document (120). More generally, the printer-related device performs a decryptionoriented action on the document. The decryption-oriented action undoes the encryption-oriented action performed by the host device in 110.

The printer-related device finally rasterizes the document (122), and prints the document (124). Rasterization is the process by which a page is prepared for printing. Rasterization may be performed by a raster image processor (RIP), which turns text and images into the matrix of pixels (a bitmap) that will be printed on the page. In the case where the printer-related device is a printer, it performs both the rasterization and the printing. In the case where the printer-related device is not a printer, it may send the document to the printer for rasterization and printing, or may initially perform the rasterization, and then send the document to the printer for printing.

Rasterization and Compression Embodiment

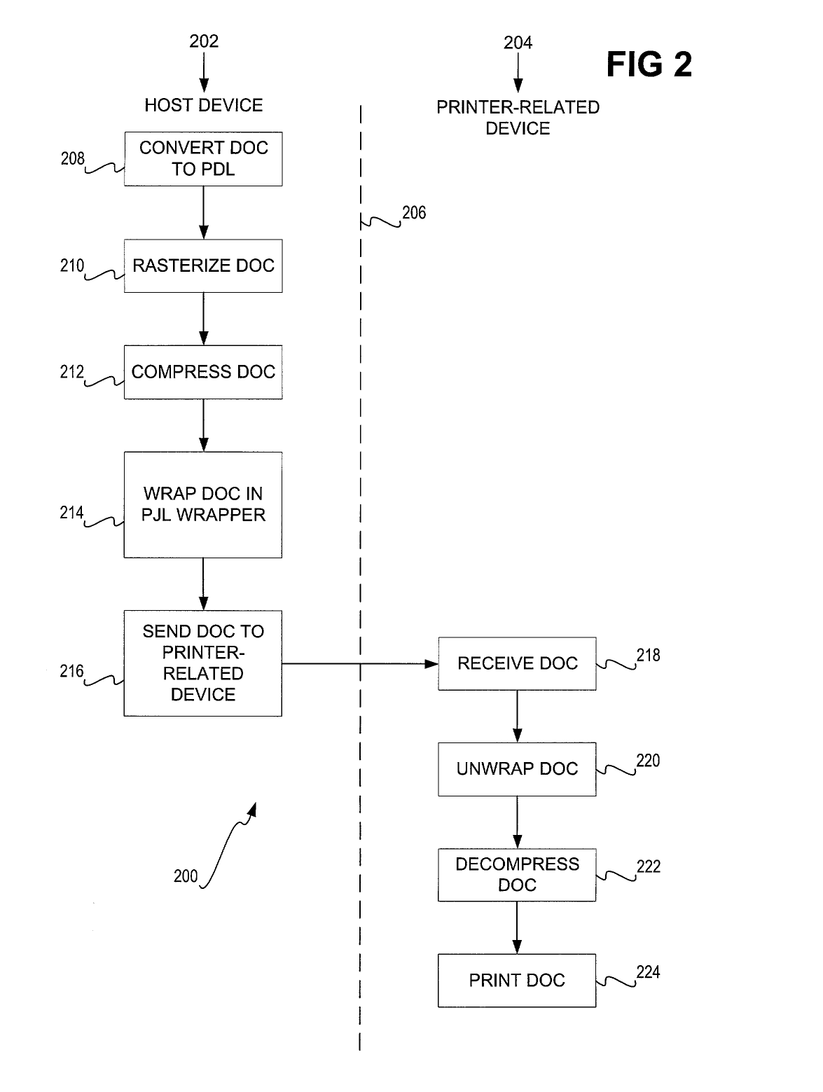

FIG. 2 shows a method 200 according to an embodiment of the invention in which a document is rasterized and compressed before being transmitted over a network. Parts of the method 200 are performed at a host device, as indicated by the column 202, whereas other parts of the method 200 are performed at a printer-related device, as indicated by the column 204. The columns 202 and 204 are separated by the dotted line 206.

The host device first converts a document to be printed to a PDL (208), and then rasterizes the document (210). The host device further compresses the document (212). More generally, such compression is another example of an encryption-oriented action being performed on the document. That is, an encryption-oriented action as used herein includes encryption, compression, or both encryption and compression. Compression is generally the encoding of data so that it takes up less space. Next, the host device wraps the document in a PJL wrapper (214), which includes a decryption-oriented action command, and sends the document to the printer-related device (216). Because an encryption-oriented action has been performed on the document—e.g., compression—the document is generally secure while it is being transmitted over the network.

The printer-related device receives the document (218), and unwraps it from the PJL wrapper (220). In unwrapping the document from its PJL wrapper, the printer-related device encounters the decryption-oriented action command. Upon encountering this command, the printer-related device decompresses the document (222). More generally, such decompression is another example of a decryption-oriented action being performed on the document. That is, a decryption-oriented action as used herein includes decryption, decompression, and both decryption and decompression. The printer-related device finally prints the document (224). Where the printer-related device is a printer, it prints the document itself. Where the printer-related device is not a printer, it sends the document to the printer for printing.

System Topologies

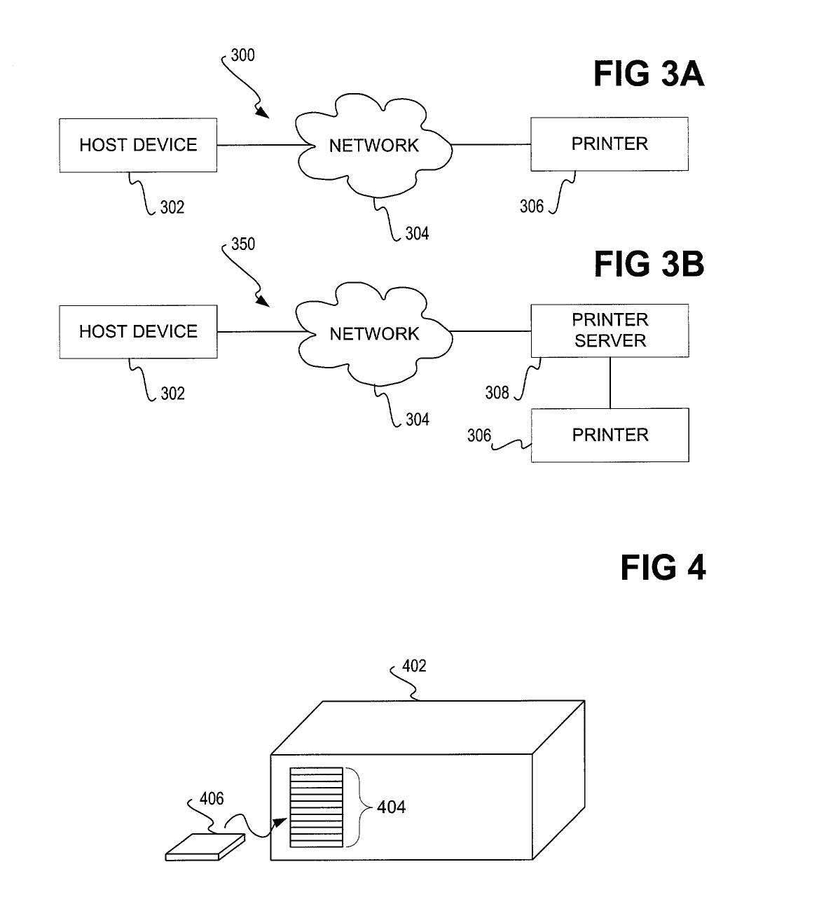

FIGS. 3A and 3B show different systems 300 and 350, according to varying embodiments of the invention. The methods 100 and 200 of FIGS. 1 and 2, respectively, can be implemented and performed in conjunction with the systems 300 and 350, for instance. In FIG. 3A, both a host device 302 and a printer 306 are communicatively coupled to a network 304. The host device 302 may be a desktop or laptop computer, a PDA device, or another type of computerized device. The printer 306 is in the system 300 specifically the printer-related device as has been referred to in previous sections of the detailed description. The network 304 may be one or more of a local-area network (LAN), a wide-area network (WAN), an intranet, an extranet, and the Internet. The network 304 may also be one or more of a wired network, a wireless network, a telephony network, and a wireless telephony network.

In FIG. 3B, the host device 302 and a printer server 308 are communicatively coupled to the network 304. The printer server 308 is inserted between the network 304 and the printer 306. The printer server 308 is in the system 350 specifically the printer-related device as has been referred to in previous sections of the detailed description. Other types of printer-related devices, besides the printer 306 of FIG. 3A and the printer server 308 of FIG. 3B, can be used as well.

In both the system 300 of FIG. 3A and the system 350 of FIG. 3B, the host device 302 is capable of converting a document according to a format, such as a PDL, as has been described. The host device 302 is further capable of performing an encryption-oriented action on the document, and wrapping the document in a wrapper having a decryption-oriented action command. The printer-related device, either the printer 306 in the system 300 of FIG. 3A or the printer server 308 in the system 350 of FIG. 3B, is capable of receiving the document from the host device 302 over the network 304. The printer-related device is further capable of unwrapping the document, of performing a decryption-oriented action on the document upon encountering the decryption-oriented action command, and of printing the document.

Printer-Related Device Add-Ins and Embedded Virtual Machine-Enabled Printers

The printer-related device may be able to perform the decryption-oriented action, as has been described in previous sections of the detailed description, in conjunction with one or more add-in cards that may be inserted into the printer-related device. This is shown in FIG. 4. The printer-related device 402 is depicted in FIG. 4 generically as a box, but may be a printer, and/or have another form factor. A number of slots 404 in the printer-related device 402 are receptive to add-in cards, such as the add-in card 406 as specifically illustrated in FIG. 4. The add-in cards may be PC Cards, for instance. Other types of add-ins, such as CD-ROM's, and other types of removable or permanent storage, may also be used.

In one embodiment, the add-in to the printer-related device performs the actual decryption-oriented action on the document. Thus, when the printer-related device encounters the decryption-oriented action command while unwrapping the document, the printer-related device sends the document to one of its add-ins for performing the decryption-oriented action. A different add-in may be included in the printer-related device for each different type of decryption and/or decompression algorithm that may be necessary for the printer-related device to properly decrypt and/or decompress received documents for printing. Alternatively, different add-ins may be included for different sets of remote users of the printer-related device, where the decryption-oriented action to be performed on documents by a given add-in is particular to a given user's or set of users' identity.

In another embodiment, the add-in to the printer-related device does not actually perform the decryption-oriented action on the document, but provides parameters to the printer-related device so the printer-related device can properly perform a decryption-oriented action on the document. Thus, when the printer-related device encounters the decryption-oriented action command while unwrapping the document, it references one of its add-ins for the parameters needed to successfully perform the decryption-oriented action. Such parameters may include decryption keys, specific decryption and/or decompression algorithms, identities of specific decryption and/or decompression algorithms, and so on.

For example, the printer-related device may access the add-in to obtain the decryption key to be used to decrypt the document. As another example, the printer-related device may import a specific decryption and/or decompression algorithm from the add-in to perform on the document, where the printer-related device actually performs the algorithm. As a final example, the printer-related device may be capable of performing a number of different decryption and/or decompression algorithms, but references the add-in to determine which algorithm to use on a particular document. The particular algorithm to be used may be based on the identity of the user, the type of document, and so on.

Furthermore, some printers, such as the LaserJet 4100 series available from the Hewlett-Packard Company, of Palo Alto, Calif., have built-in embedded virtual machines (EVM's). These EVM's enable software to be uploaded to the printers, for execution within and/or by the EVM's. Therefore, in one embodiment of the invention, the decryption and/or decompression that has been described in conjunction with add-ins can instead be performed by an EVM.

Computer Program

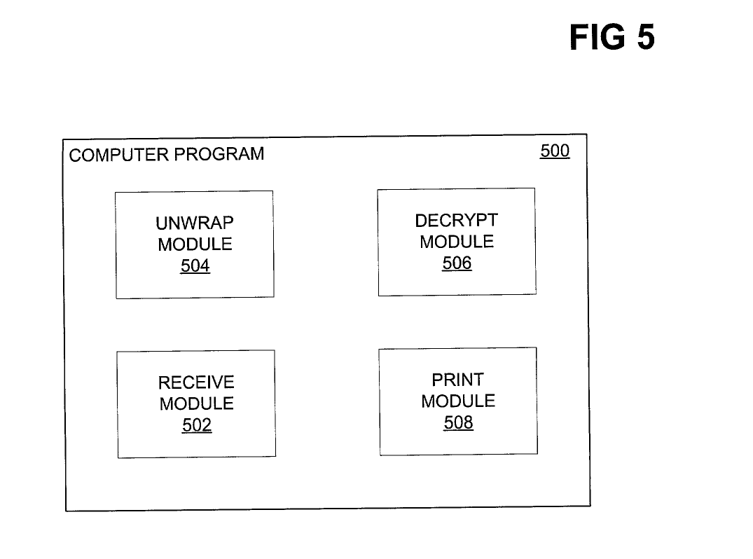

FIG. 5 shows a computer program 500 according to an embodiment of the invention. The computer program 500 is executed by a printer-related device, as has been described in previous sections of the detailed description. The computer program 500 may be stored on a computer-readable medium. The medium may be a hard disk drive or other permanent storage, a CD-ROM, a floppy disk, or other removable storage, or another type of computer-readable medium.

The computer program 500 includes a receive module 502, an unwrap module 504, a decrypt module 506, and a print module 508. Each of these modules 502, 504, 506, and 508 may be one or more separate sets of instructions, components, or mechanisms understood by the printer-related device. Furthermore, whereas the modules 502, 504, 506, and 508 are shown as separate modules in FIG. 5 for illustrative clarity, the functionality of one or more of the modules 502, 504, 506, and 508 may be performed by the same module, or the functionality may be divided among the modules in a manner different than that shown in FIG. 5.

The receive module 502 receives a document from a host device over a network. The host device has performed an encryption-oriented action on the document, and has also wrapped the document in a wrapper. The unwrap module 504 unwraps the document from its wrapper, and the decrypt module 506 performs a decryption-oriented action on the document upon the unwrap module 504 encountering a decryption-oriented action command while unwrapping the document. Finally, the print module 506 prints the document after it has been unwrapped and after the decryption-oriented action has been performed on the document.

Conclusion

It is noted that, although specific embodiments have been illustrated and described herein, it will be appreciated by those of ordinary skill in the art that any arrangement is calculated to achieve the same purpose may be substituted for the specific embodiments shown. For example, other applications and uses of embodiments of the invention, besides those described herein, are amenable to at least some embodiments. This application is intended to cover any adaptations or variations of the present invention.

As another example, whereas one embodiment of the invention has been described as performing encryption prior to network transmission, and another embodiment of the invention has been described as performing rasterization and compression prior to network transmission, the invention includes other, alternative embodiments as well. Encryption and compression, rasterization and encryption, as well as rasterization, compression, and encryption, for instance, may be performed prior to network transmission. Therefore, it is manifestly intended that this invention be limited only by the claims and equivalents thereof.

What is claimed is:

1. A method comprising:
converting a document to be printed at a host device;
performing an encryption-oriented action on the document at the host device;
wrapping the document in a wrapper having a decryption-oriented action command at the host device;
sending the document from the host device to a printer-related device over a network;
unwrapping the document from the wrapper at the printer-related device;
upon encountering the decryption-oriented action command while unwrapping the document at the printer-related device, performing a decryption-oriented action on the document at the printer-related device; and,
printing the document.

2. The method of claim 1, wherein converting the document to be printed comprises at least one of converting the document to a page definition language (PDL) and rasterizing the document.

3. The method of claim 1, wherein performing the encryption-oriented action comprises at least one of encrypting the document and compressing the document.

4. The method of claim 1, wherein wrapping the document in the wrapper comprises wrapping the document in a printer-job language (PJL) wrapper.

5. The method of claim 1, wherein performing the decryption-oriented action comprises at least one of decrypting the document and decompressing the document.

6. The method of claim 1, wherein printing the document comprises sending the document to a printer.

7. The method of claim 1, wherein printing the document comprises rasterizing the document.

8. A system comprising:
a network;
a host device capable of converting a document according to a format, performing an encryption-oriented action on the document, and wrapping the document in a wrapper having a decryption-oriented action command; and,
a printer-related device capable of receiving the document from the host device over the network, unwrapping the document, performing a decryption-oriented action on the document upon encountering the decryption-oriented action command, and printing the document.

9. The system of claim 8, wherein the network comprises at least one of the Internet, an intranet, an extranet, a local-area network (LAN), a wide-area network (WAN), a wired network, a wireless network, a telephony network, and a wireless telephony network.

10. The system of claim 8, wherein the format comprises a page-description language (PDL).

11. The system of claim 8, wherein the encryption-oriented action comprises at least one of encryption and compression, and the decryption-oriented action comprises at least one of decryption and decompression.

12. The system of claim 8, wherein the wrapper comprises a printer-job language (PJL) wrapper.

13. The system of claim 8, wherein the printer-related device comprises a decryption-oriented add-in capable of performing the decryption-oriented action on the document upon the printer-related device encountering the decryption-oriented action command while unwrapping the document.

14. The system of claim 13, wherein the decryption-oriented add-in is capable of performing the decryption-oriented action on the document based on an identity of the host device from which the printer-related device received the document.

15. The system of claim 8, wherein the printer-related device comprises a decryption-oriented add-in capable of providing one or more decryption-oriented parameters to the printer-related device for performing the decryption-oriented action on the document upon encountering the decryption-oriented command while unwrapping the document.

16. The system of claim 15, wherein the one or more decryption-oriented parameters comprises at least one of: a decryption key, a decryption algorithm, an identity of a decryption algorithm, a decompression algorithm, and an identity of a decryption algorithm.

17. The system of claim 8, wherein the printer-related device comprises a printer.

18. The system of claim 8, further comprising a printer, the printer-related device capable of sending the document to the printer after performing the decryption-oriented action on the document.

19. A computer-readable medium having a program stored thereon for execution by a printer-related device, the program comprising:
a module to unwrap a document from a wrapper in which the document has been wrapped by a host device; and,
a module to perform a decryption-oriented action on the document upon the module to unwrap the document encountering a decryption-oriented action command while unwrapping the document.

20. The medium of claim 19, the program further comprising:
a module to receive the document from the host device over a network; and,
a module to print the document after the document has been unwrapped and the decryption-oriented action has been performed thereon.
